(19) United States
(12) Patent Application Publication
(10) Pub. No.: US 2017/0025751 A1
(43) Pub. Date: Jan. 26, 2017

(54) Fan Beam Antenna

(71) Applicant: Google Inc., Mountain View, CA (US)

(72) Inventors: Christopher White, Portola Valley, CA (US); Dedi David Haziza, Sunnyvale, CA (US); Helen Kankan Pan, Saratoga, CA (US); Sean McCully, Dublin, CA (US)

(73) Assignee: Google Inc., Mountain View, CA (US)

(21) Appl. No.: 14/806,049

(22) Filed: Jul. 22, 2015

(51) Int. Cl. H01Q 3/04; H01Q 19/10

(52) U.S. Cl. CPC H01Q 3/04; H01Q 19/10

(57) ABSTRACT

A fan beam antenna includes a parallel plate waveguide configured to guide electromagnetic energy of an emission beam and a reflector disposed on the parallel plate waveguide configured to reflect the electromagnetic energy of the emission beam. The fan beam antenna further includes a plurality of radiating elements disposed on the parallel plate waveguide configured to transmit and/or receive the electromagnetic energy of the emission beam and a microwave transceiver module in communication with the plurality of radiating elements.

### TECHNICAL FIELD

This disclosure relates to fan beam antennas.

### BACKGROUND

A communication network is a large distributed system for receiving information (signal) and transmitting the information to a destination. Over the past few decades the demand for communication access has dramatically increased. Although conventional wire and fiber landlines, cellular networks, and geostationary satellite systems have continuously been increasing to accommodate the growth in demand, the existing communication infrastructure is still not large enough to accommodate the increase in demand. In addition, some areas of the world are not connected to a communication network and therefore cannot be part of the global community where everything is connected to the internet.

Satellites are used to provide communication services to areas where wired cables cannot reach. Satellites may be geostationary or non-geostationary. Geostationary satellites remain permanently in the same area of the sky as viewed from a specific location on earth, because the satellite is orbiting the equator with an orbital period of exactly one day. Non-geostationary satellites typically operate in low- or mid-earth orbit, and do not remain stationary relative to a fixed point on earth; the orbital path of a satellite can be described in part by the plane intersecting the center of the earth and containing the orbit. Each satellite may be equipped with communication devices called inter-satellite links (or, more generally, inter-device links) to communicate with other satellites in the same plane or in other planes. The communication devices allow the satellites to communicate with other satellites. These communication devices are expensive and heavy. In addition, the communication devices significantly increase the cost of building, launching and operating each satellite; they also greatly complicate the design and development of the satellite communication system and associated antennas and mechanisms to allow each satellite to acquire and track other satellites whose relative position is changing. Each antenna has a mechanical or electronic steering mechanism, which adds weight, cost, vibration, and complexity to the satellite, and increases risk of failure. Requirements for such tracking mechanisms are much more challenging for inter-satellite links designed to communicate with satellites in different planes than for links, which only communicate with nearby satellites in the same plane, since there is much less variation in relative position. Similar considerations and added cost apply to high-altitude communication balloon systems with inter-balloon links.

### SUMMARY

One aspect of the disclosure provides a fan beam antenna. The fan beam antenna includes a parallel plate waveguide configured to guide electromagnetic energy of an emission beam and a reflector disposed on the parallel plate waveguide configured to reflect the electromagnetic energy of the emission beam. The antenna further includes a plurality of radiating elements disposed on the parallel plate waveguide configured to transmit and/or receive the electromagnetic energy of the emission beam and a microwave transceiver module in communication with the plurality of radiating elements. The fan beam antenna includes a rotation assembly disposed on the parallel plate waveguide configured to rotate the parallel plate waveguide about a rotation axis defined substantially normal to a broad surface of the parallel plate waveguide.

Implementations of the disclosure may include one or more of the following optional features. In some implementations, the axis of rotation is the sole axis of rotation. The rotation assembly is further configured to rotate the parallel plate waveguide while maintaining the parallel plate waveguide within a plane of rotation. Additionally or alternatively, the rotation assembly may include a motor coupled to the parallel plate waveguide and a position sensor configured to sense an angle of rotation of the parallel plate waveguide about the rotation axis.

In some examples, the rotation assembly further includes an antenna alignment controller in communication with the position sensor and the motor. The antenna alignment controller is configured to control the angle of rotation of the parallel plate waveguide about the rotation axis by comparing a first position of the fan beam antenna with a second position of the ground station and determining an alignment angle of rotation of the parallel plate waveguide about the rotation axis to establish a communication link between the fan beam antenna and the ground station.

The transceiver module may include a modem configured to provide data to the plurality of radiating elements. The plurality of radiating elements may be configured to transmit and receive data at a frequency greater than 5.8 GHz. The emission beam may have a half power full beam height along a first axis of between about 0.1 degrees and about 5 degrees and a beam width along a second axis perpendicular to the first axis of between about 10 degrees and about 70 degrees.

Another aspect of the disclosure provides a communication system. The communication system includes an unmanned aerial system, a fan beam antenna disposed on the unmanned aerial system, and a ground station in communication with the fan beam antenna disposed on the antenna aerial system. The fan beam includes a parallel plate waveguide configured to guide electromagnetic energy of an emission beam and a reflector disposed on the parallel plate waveguide configured to reflect the electromagnetic energy of the emission beam. The fan beam antenna further includes a plurality of radiating elements disposed on the parallel plate waveguide configured to transmit and/or receive the electromagnetic energy of the emission beam and a microwave transceiver module in communication with the plurality of radiating elements. This aspect may include one or more of the following optional features. The communication system further includes a rotation assembly disposed on the unmanned aerial system and rotatably supporting the fan beam antenna.

In some implementations, the unmanned aerial system moves along a closed loop path and the rotation assembly rotates about a rotation axis defined substantially normal to a broad surface of the parallel plate waveguide to maintain communication with the ground station. The rotation assembly is configured to rotate the fan beam antenna while maintaining the parallel plate waveguide within a plane of rotation. The rotation assembly may further include a motor coupled to the parallel plate waveguide and a position sensor configured to sense an angle of rotation of the parallel plate waveguide about the rotation axis. The motor may rotate the fan beam antenna in relation to a signal strength of the emission beam.

In some implementations, the unmanned aerial system includes a body, a global positioning system disposed on the body and an antenna alignment controller in communication with the global positioning system, the position sensor, and the motor. The antenna controller is configured to control the angle of rotation of the parallel plate waveguide about the rotation axis by controlling the motor. The antenna alignment controller controls the angle of rotation of the parallel plate waveguide about the rotation axis by comparing a first position determined by the global positioning system with a second position of the ground station and determining an alignment angle of rotation of the parallel plate waveguide about the rotation axis to establish a communication link between the fan beam antenna and the ground station. The plurality of radiating elements is configured to transmit and receive data at a frequency greater than 5.8 GHz. The emission beam may have a half power full beam height along a first axis of between about 0.1 degrees and about 5 degrees and a beam width along a second axis perpendicular to the first axis of between about 10 degrees and about 70 degrees.

Yet another aspect of the disclosure provides a method for operating a fan beam antenna. The method includes operating, using data processing hardware, an unmanned aerial system having a fan beam antenna in communication with the data processing hardware. The fan beam antenna includes a parallel plate waveguide configured to guide electromagnetic energy and a reflector disposed on the parallel plate waveguide and configured to reflect the electromagnetic energy. The fan beam antenna further includes a plurality of radiating elements disposed on the parallel plate waveguide configured to transmit a first emission beam to a ground station and/or receive a second emission beam from the ground station and a microwave transceiver module in communication with the plurality of radiating elements. The method further includes rotation the fan beam antenna to establish a communication link between the fan beam antenna and the ground station, transmitting, by the data processing hardware, downlink data in the first emission beam from the fan beam antenna to the ground station and receiving uplink data in the second emission beam from the ground station to the fan beam antenna of the unmanned aerial system. Rotating the fan beam antenna includes rotating the parallel plate waveguide about a rotation axis defined substantially normal to a broad surface of the parallel plate waveguide.

In some examples, the rotation axis is the sole axis of rotation. The method may further include rotating the fan beam antenna while maintaining the parallel plate waveguide within a plane of rotation. The method further includes receiving, at the data processing hardware, a first position from a global positioning system of the unmanned aerial system, comparing, at the data processing hardware, the first position with a second position of the ground station and controlling, by the data processing hardware, the rotating of the fan beam antenna to maintain the communication link between the fan beam antenna and the ground station.

The plurality of radiating elements may be configured to transmit and receive data at a frequency greater than 5.8 GHz. Each emission beam may have a half power full beam height along a first axis of between about 0.1 degrees and about 5 degrees and a beam width along a second axis perpendicular to the first axis of between about 10 degrees and about 70 degrees. The method may further include transmitting the downlink data in the first emission beam from the fan beam antenna to the ground station via an electromagnetic wave having a frequency greater than about 30 GHz.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1A is a schematic view of an exemplary communication system.

FIG. 1B is a schematic view of an exemplary global-scale communication system with satellites and communication balloons, where the satellites form a polar constellation.

FIG. 1C is a schematic view of an exemplary group of satellites of FIG. 1A forming a Walker constellation.

FIGS. 2A and 2B are perspective views of example high-altitude platforms.

FIG. 3 is a perspective view of an example satellite.

FIG. 4 is a schematic view of an exemplary communication system that includes a high altitude platform and a ground terminal.

FIG. 5A is a perspective view of an exemplary rotating fan beam antenna.

FIG. 5B is a side view of the rotating fan beam antenna shown in FIG. 5A.

FIG. 5C is a top view of the rotating fan beam antenna shown in FIG. 5A.

FIG. 5D is a section side view of the rotating fan beam antenna shown in FIG. 5C along line 5D-5D.

FIG. 5E is a bottom view of an exemplary rotating fan beam antenna.

FIG. 6 is a schematic view of an exemplary antenna system controller for a rotating fan beam antenna.

FIG. 7A is a top view of an exemplary emission beam from a rotating fan beam antenna.

FIG. 7B is a schematic view of an exemplary emission beam from the fan beam antenna attached to a high altitude platform in communication with a ground station.

FIG. 8 is a perspective view of an exemplary emission beam from a rotating fan beam antenna.

FIG. 9 is a schematic view of a method for operating an exemplary rotating fan beam antenna.

Like reference symbols in the various drawings indicate like elements.

### DETAILED DESCRIPTION

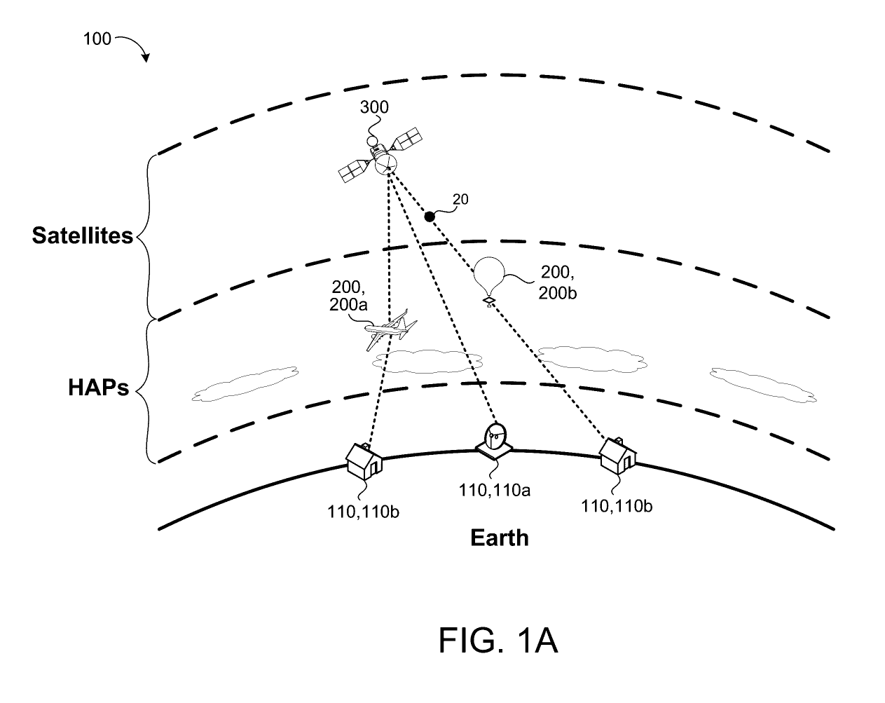

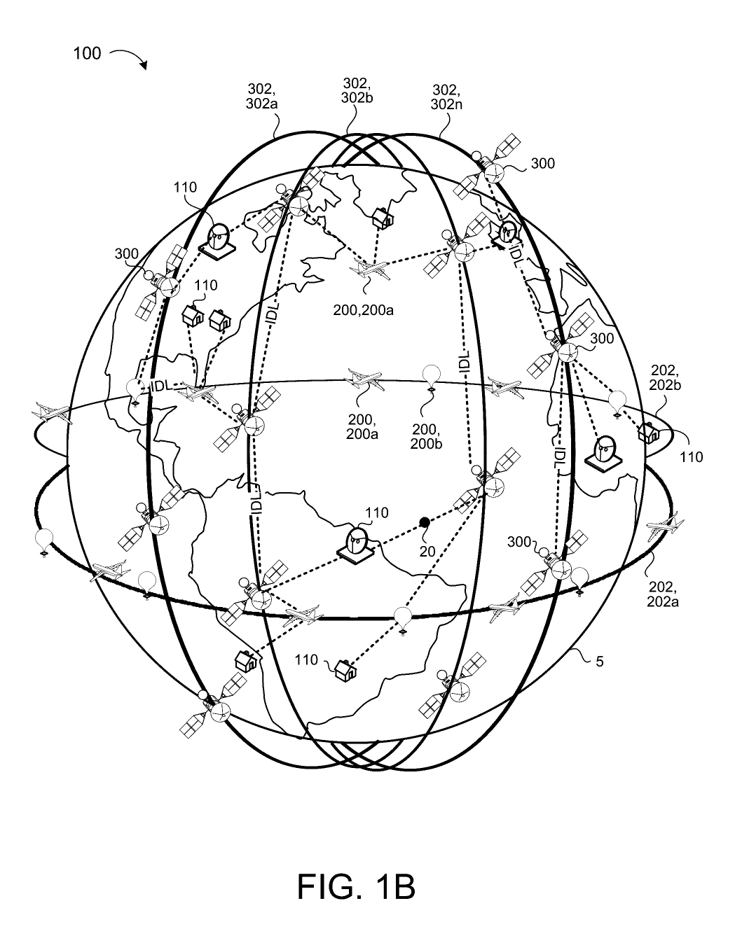

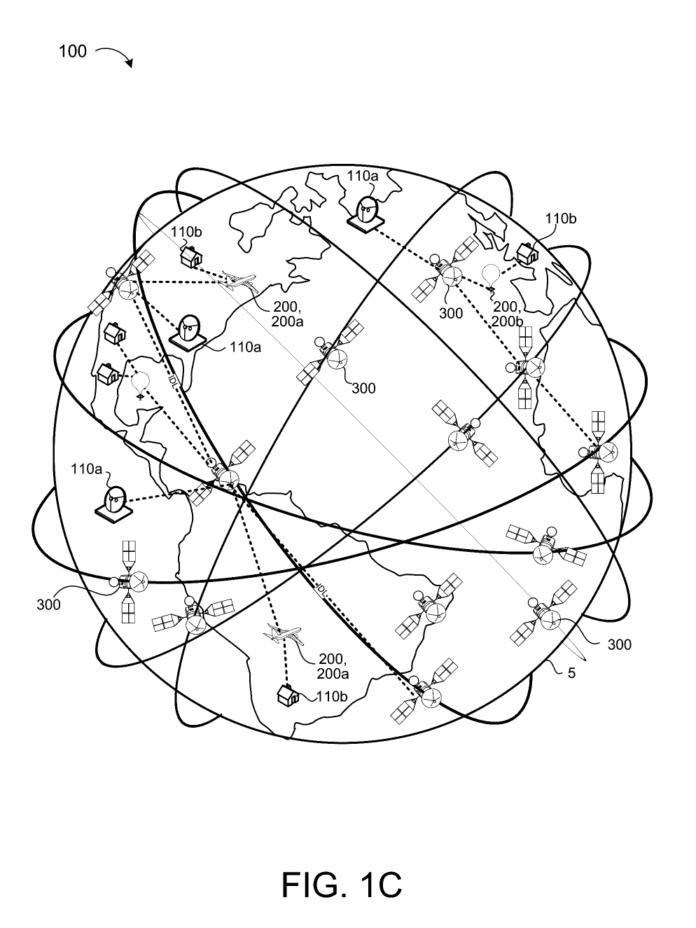

Referring to FIGS. 1A-IC, in some implementations, a global-scale communication system 100 includes gateways 110 (e.g., source ground stations 110a and destination ground stations 110b), high altitude platforms (HAPs) 200, and satellites 300. The source ground stations 110a may communicate with the satellites 300, the satellites 300 may communicate with the HAPs 200, and the HAPs 200 may communicate with the destination ground stations 110b. In some examples, the source ground stations 110a also operate as linking-gateways between satellites 300. The source ground stations 110a may be connected to one or more service providers and the destination ground stations 110b may be user terminals (e.g., mobile devices, residential WiFi devices, home networks, etc.). In some implementations, a HAP 200 is an aerial communication device that operates at high altitudes (e.g., 17-22 km). The HAP may be released into the earth's atmosphere, e.g., by an air craft, or flown to the desired height. Moreover, the HAP 200 may operate as a quasi-stationary aircraft. In some examples, the HAP 200 is an aircraft 200a, such as an unmanned aerial vehicle (UAV); while in other examples, the HAP 200 is a communication balloon 200b. The satellite 300 may be in Low Earth Orbit (LEO), Medium Earth Orbit (MEO), or High Earth Orbit (HEO), including Geosynchronous Earth Orbit (GEO).

The HAPs 200 may move about the earth 5 along a path, trajectory, or orbit 202 (also referred to as a plane, since their orbit or trajectory may approximately form a geometric plane). Moreover, several HAPs 200 may operate in the same or different orbits 202. For example, some HAPs 200 may move approximately along a latitude of the earth 5 (or in a trajectory determined in part by prevailing winds) in a first orbit 202a, while other HAPs 200 may move along a different latitude or trajectory in a second orbit 202b. The HAPs 200 may be grouped amongst several different orbits 202 about the earth 5 and/or they may move along other paths 202 (e.g., individual paths). Similarly, the satellites 300 may move along different orbits 302, 302a-n. Multiple satellites 300 working in concert form a satellite constellation. The satellites 300 within the satellite constellation may operate in a coordinated fashion to overlap in ground coverage. In the example shown in FIG. 1B, the satellites 300 operate in a polar constellation by having the satellites 300 orbit the poles of the earth 5; whereas, in the example shown in FIG. 1C, the satellites 300 operate in Walker constellation, which covers areas below certain latitudes and provides a larger number of satellites 300 simultaneously in view of a gateway 110 on the ground (leading to higher availability, fewer dropped connections).

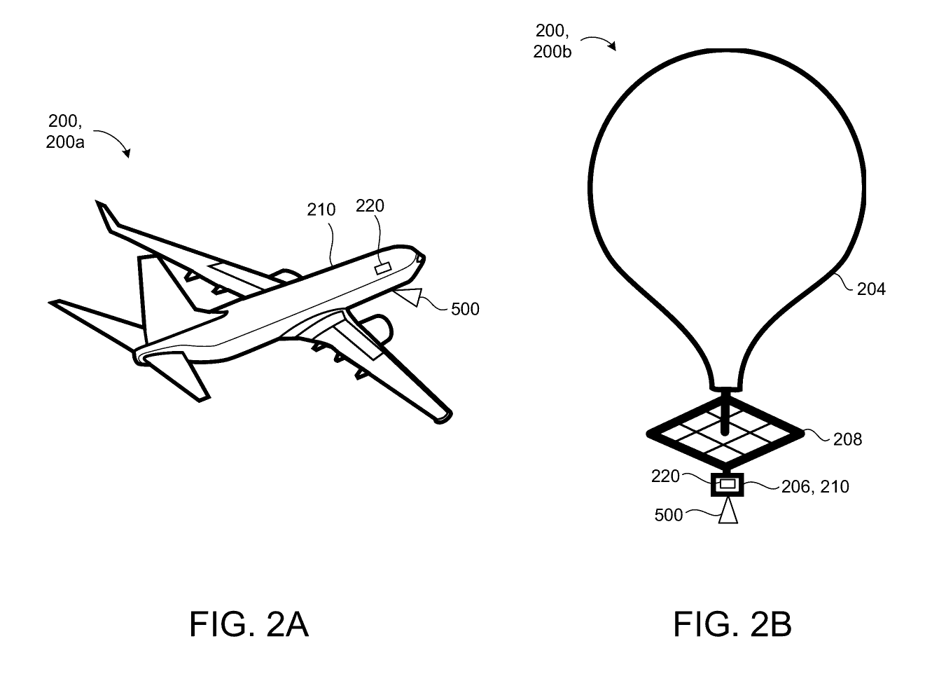

Referring to FIGS. 2A and 2B, in some implementations, the HAP 200 includes a HAP body 210 and an antenna 500 disposed on the HAP body 210 that receives a communication 20 from a satellite 300 and reroutes the communication 20 to a destination ground station 110b and vice versa. The HAP 200 may include a data processing device 220 that processes the received communication 20 and determines a path of the communication 20 to arrive at the destination ground station 110b (e.g., user terminal). In some implementations, user terminals 110b on the ground have specialized antennas that send communication signals to the HAPs 200. The HAP 200 receiving the communication 20 sends the communication 20 to another HAP 200, to a satellite 300, or to a gateway 110 (e.g., a user terminal 110b).

FIG. 2B illustrates an example communication balloon 200b that includes a balloon 204 (e.g., sized about 49 feet in width and 39 feet in height and filled with helium or hydrogen), an equipment box 206 as a HAP body 210, and solar panels 208. The equipment box 206 includes a data processing device 310 that executes algorithms to determine where the high-altitude balloon 200a needs to go, then each high-altitude balloon 200b moves into a layer of wind blowing in a direction that will take it where it should be going. The equipment box 206 also includes batteries to store power and a transceiver (e.g., antennas 500) to communicate with other devices (e.g., other HAPs 200, satellites 300, gateways 110, such as user terminals 110b, internet antennas on the ground, etc.). The solar panels 208 may power the equipment box 206.

Communication balloons 200a are typically released in to the earth's stratosphere to attain an altitude between 11 to 23 miles and provide connectivity for a ground area of 25 miles in diameter at speeds comparable to terrestrial wireless data services (such as, 3G or 4G). The communication balloons 200a float in the stratosphere at an altitude twice as high as airplanes and the weather (e.g., 20 km above the earth's surface). The high-altitude balloons 200a are carried around the earth 5 by winds and can be steered by rising or descending to an altitude with winds moving in the desired direction. Winds in the stratosphere are usually steady and move slowly at about 5 and 20 mph, and each layer of wind varies in direction and magnitude.

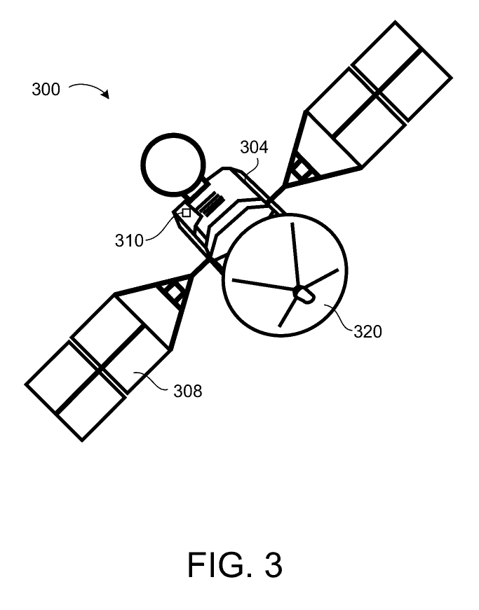

Referring to FIG. 3, a satellite 300 is an object placed into orbit 302 around the earth 5 and may serve different purposes, such as military or civilian observation satellites, communication satellites, navigations satellites, weather satellites, and research satellites. The orbit 302 of the satellite 300 varies depending in part on the purpose of the satellite 200b. Satellite orbits 302 may be classified based on their altitude from the surface of the earth 5 as Low Earth Orbit (LEO), Medium Earth Orbit (MEO), and High Earth Orbit (HEO). LEO is a geocentric orbit (i.e., orbiting around the earth 5) that ranges in altitude from 0 to 1,240 miles. MEO is also a geocentric orbit that ranges in altitude from 1,200 mile to 22,236 miles. HEO is also a geocentric orbit and has an altitude above 22,236 miles. Geosynchronous Earth Orbit (GEO) is a special case of HEO. Geostationary Earth Orbit (GSO, although sometimes also called GEO) is a special case of Geosynchronous Earth Orbit.

In some implementations, a satellite 300 includes a satellite body 304 having a data processing device 310, e.g., similar to the data processing device 310 of the HAPs 200. The data processing device 310 executes algorithms to determine where the satellite 300 is heading. The satellite 300 also includes an antenna 320 for receiving and transmitting a communication 20. The satellite 300 includes solar panels 308 mounted on the satellite body 204 for providing power to the satellite 300. In some examples, the satellite 300 includes rechargeable batteries used when sunlight is not reaching and charging the solar panels 308.

When constructing a global-scale communications system 100 using HAPs 200, it is sometimes desirable to route traffic over long distances through the system 100 by linking HAPs 200 to satellites 300 and/or one HAP 200 to another. For example, two satellites 300 may communicate via inter-device links and two HAPs 200 may communicate via inter-device links. Inter-device link (IDL) eliminates or reduces the number of HAPs 200 or satellites 300 to gateway 110 hops, which decreases the latency and increases the overall network capabilities. Inter-device links allow for communication traffic from one HAP 200 or satellite 300 covering a particular region to be seamlessly handed over to another HAP 200 or satellite 300 covering the same region, where a first HAP 200 or satellite 300 is leaving the first area and a second HAP 200 or satellite 300 is entering the area. Such inter-device linking IDL is useful to provide communication services to areas far from source and destination ground stations 110a, 110b and may also reduce latency and enhance security (fiber optic cables may be intercepted and data going through the cable may be retrieved). This type of inter-device communication is different than the “bent-pipe” model, in which all the signal traffic goes from a source ground station 110a to a satellite 300, and then directly down to a to destination ground station 110b (e.g., user terminal) or vice versa. The “bent-pipe” model does not include any inter-device communications. Instead, the satellite 300 acts as a repeater. In some examples of “bent-pipe” models, the signal received by the satellite 300 is amplified before it is re-transmitted; however, no signal processing occurs. In other examples of the “bent-pipe” model, part or all of the signal may be processed and decoded to allow for one or more of routing to different beams, error correction, or quality-of-service control; however no inter-device communication occurs.

In some implementations, large-scale communication constellations are described in terms of a number of orbits 202, 302, and the number of HAPs 200 or satellites 300 per orbit 202, 302. HAPs 200 or satellites 300 within the same orbit 202, 302 maintain the same position relative to their intra-orbit HAP 200 or satellite 300 neighbors. However, the position of a HAP 200 or a satellite 300 relative to neighbors in an adjacent orbit 202, 302 may vary over time. For example, in a large-scale satellite constellation with near-polar orbits, satellites 300 within the same orbit 202 (which corresponds roughly to a specific latitude, at a given point in time) maintain a roughly constant position relative to their intra-orbit neighbors (i.e., a forward and a rearward satellite 300), but their position relative to neighbors in an adjacent orbit 302 varies over time. A similar concept applies to the HAPs 200; however, the HAPs 200 move about the earth 5 along a latitudinal plane and maintain roughly a constant position to a neighboring HAP 200.

A source ground station 110a may be used as a connector between satellites 300 and the internet, or between HAPs 200 and user terminals 110b. In some examples, the system 100 utilizes the source ground station 110a as linking-gateways 110a for relaying a communication 20 from one HAP 200 or satellite 300 to another HAP 200 or satellite 300, where each HAP 200 or satellite 300 is in a different orbit 202, 302. For example, the linking-gateway 110a may receive a communication 20 from an orbiting satellite 300, process the communication 20, and switch the communication 20 to another satellite 300 in a different orbit 302. Therefore, the combination of the satellites 300 and the linking-gateways 110a provide a fully-connected system 100. For the purposes of further examples, the gateways 110 (e.g., source ground stations 110a and destination ground stations 110b), shall be referred to as ground stations 110.

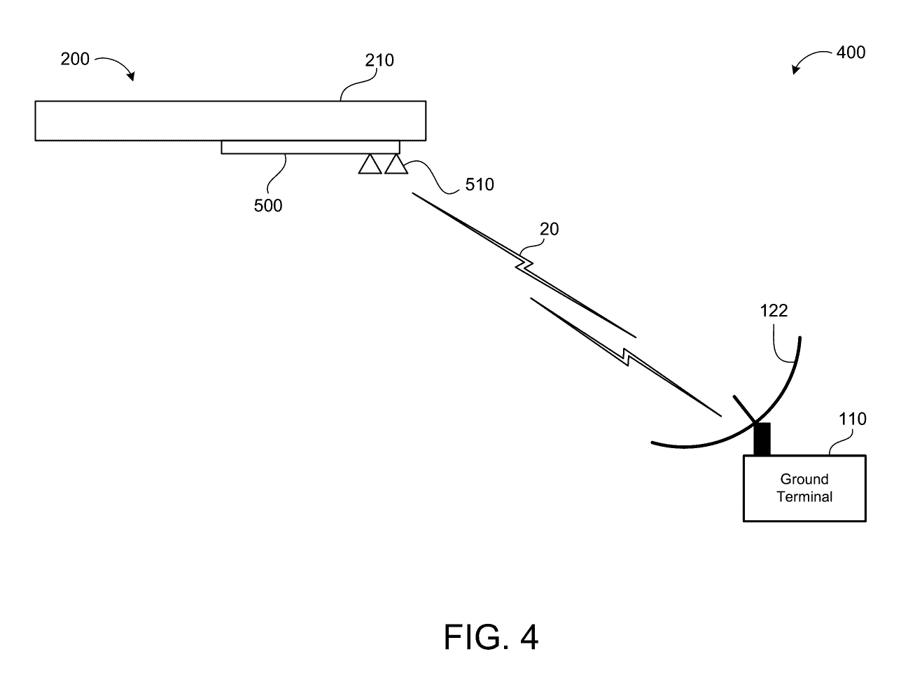

FIG. 4 provides a schematic view of an exemplary architecture of a communication system 400 establishing a communications link between a HAP 200 and a ground station 110 (e.g., a gateway 110). In some examples, the HAP 200 is an unmanned aerial system (UAS). The two terms are used interchangeably throughout this application. In the example shown, the HAP 200 includes a body 210 that supports a fan beam antenna 500, which can communicate with the ground station 110 through a communication 20 (e.g., radio signals or electromagnetic energy). The ground station 110 includes a ground antenna 122 designed to communicate with the HAP 200. The HAP 200 may communicate various data and information to the ground station 110, such as, but not limited to, airspeed, heading, attitude position, temperature, GPS (global positioning system) coordinates, wind conditions, flight plan information, fuel quantity, battery quantity, data received from other sources, data received from other antennas, sensor data, etc. The ground station 110 may communicate to the HAP 200 various data and information, such as, but not limited to, flight directions, flight condition warnings, control inputs, requests for information, requests for sensor data, data to be retransmitted via other antennas or systems, etc. The HAP 200 may be various implementations of flying craft including a combination of the following such as, but not limited to an airplane, airship, helicopter, gyrocopter, blimp, multi-copter, glider, balloon, fixed wing, rotary wing, rotor aircraft, lifting body, heavier than air craft, lighter than air craft, etc.

One of the challenges associated with establishing a communication system between a HAP 200 and ground station 110 is the movement of the HAP 200. One solution to this problem is the use of an omnidirectional antenna system on the HAP 200 and ground station 110. This present disadvantages as an omnidirectional antenna has a lower gain and therefore range in exchange for its ability to receive from all directions. A directional antenna may be used to improve the gain and range of the system, but this presents its own challenges as depending on how directional the antenna is, the craft may move out of the antennas transmission or reception area. When using a directional antenna, a system needs to move both of the antennas (i.e., the HAP antenna and the ground terminal antenna) to keep the antennas aligned between the aircraft and the ground. This becomes more challenging with greater directionality of the antenna. Additionally, various conditions may cause the HAP 200 to unintentionally move location, such as, but not limited to, wind, thermals, other craft, turbulence, etc., making the system moving the antenna forced to rapidly correct if continuous communication is required. A highly directional antenna may create a narrow cone transmission shape requiring the antenna to be moved on two axes to maintain alignment. This disclosure presents a fan beam antenna 500 having a single axis controller that allows 360 degree rotation of the antenna for continuous coverage of a link to a fixed ground station, while the HAP 200 files a nominally circular flight path.

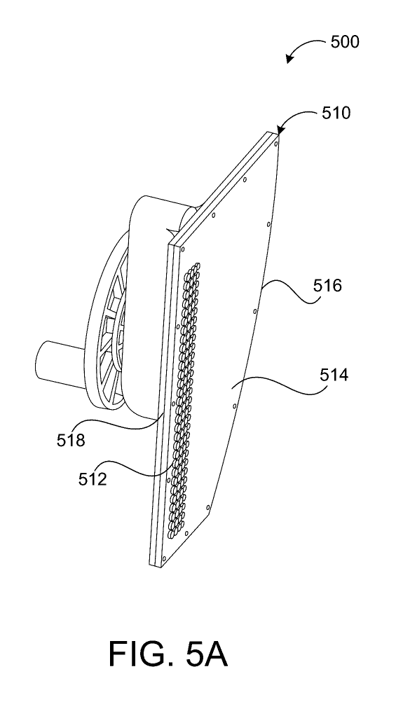

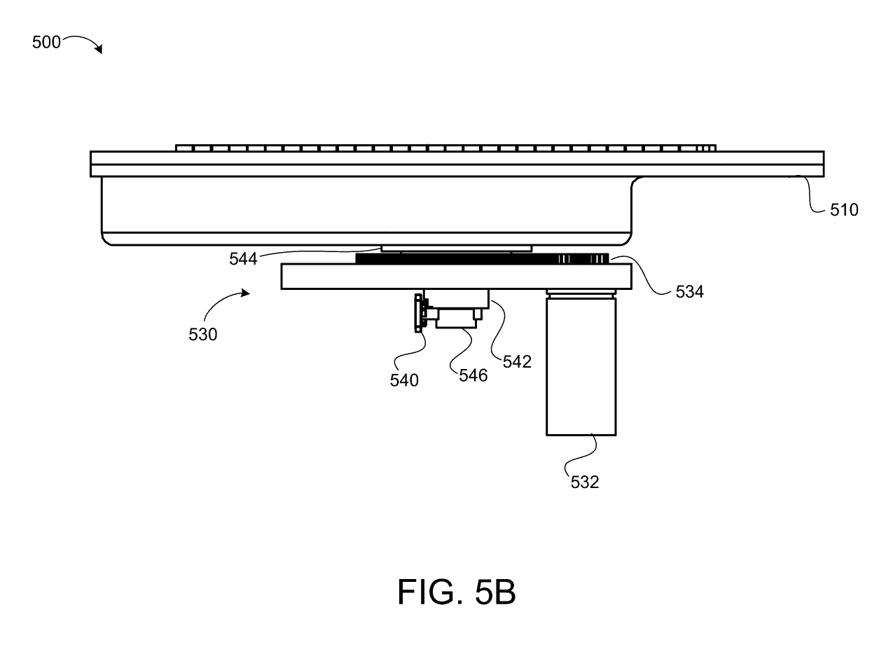

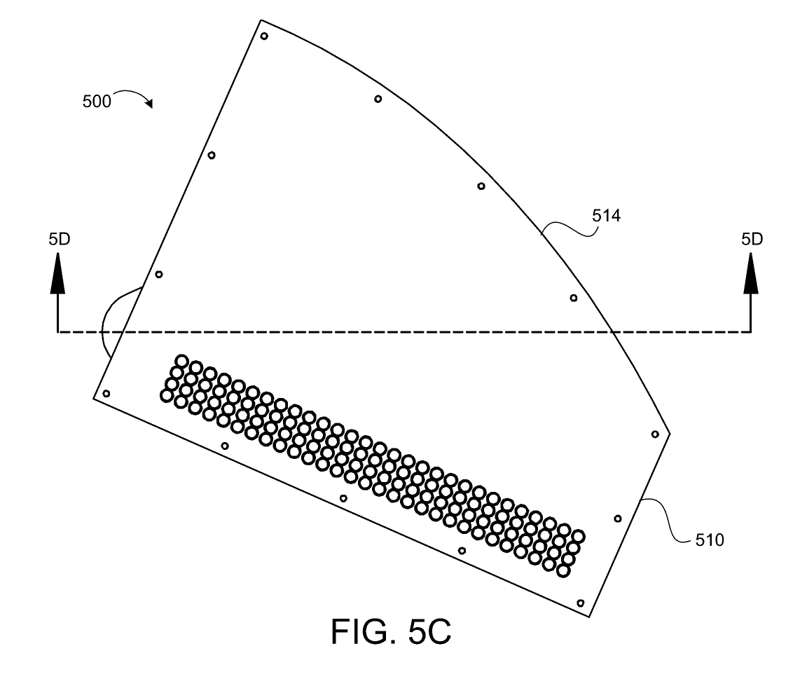

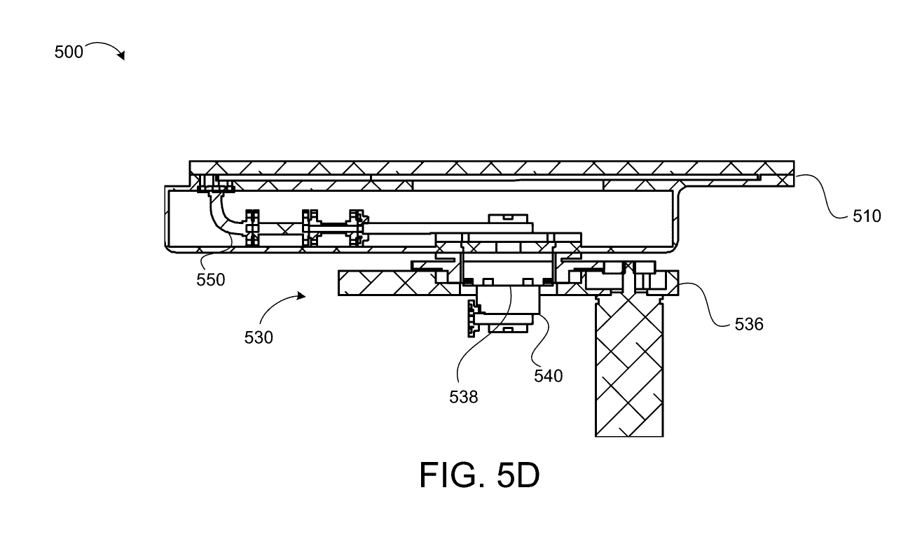

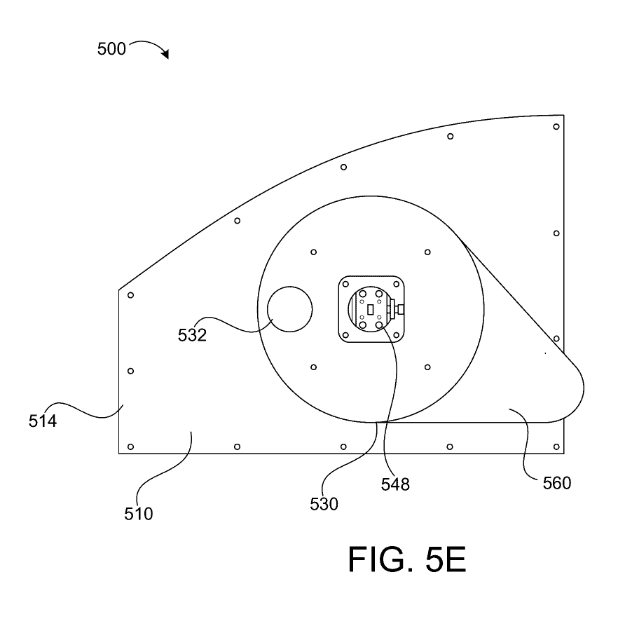

FIG. 5A provides a perspective view of an exemplary fan beam antenna 500, which may be connected to the body 210 of the HAP 200. The fan beam antenna 500 includes an antenna array 510, which includes a plurality of circular array elements 512 mounted to a parallel plate waveguide 514. The circular array elements 512 direct electromagnetic energy towards a reflector 516 attached to the parallel plate waveguide 514. The electromagnetic energy from the circular array elements 512 is then directed by the parallel plate waveguide 514 and reflector 516 out a radiating slot 518 created by the parallel plate waveguide 514. The radiating slot 518 may be created by one or more parallel plate waveguides 514 having a gap between them or it may be created by a cut within one or more of the parallel plate waveguides 514 or the reflector 516 itself.

The combination of the parallel plate waveguide 514 and reflector 516 serves to direct electromagnetic energy from the circular array elements 512 that would be emitted in a direction other than the desired direction to be reflected in the desired direction. This allows the emitted electromagnetic energy to be focused into a beam or other desired shape. In some examples, the wide beam in one axis and narrow beam in a second axis creates a fan shape emission. The parallel plate waveguide 514 and reflector 516 may be composed of a material configured to reflect electromagnetic energy in the frequencies greater than 5.8 GHz such as, but not limited to, the microwave wave frequencies 5.8 GHz to 42 GHz and millimeter wave frequencies greater than 42 GHz. The parallel plate waveguide 514 and reflector 516 may be composed of a material configured to reflect electromagnetic energy only in the microwave wave frequencies of 5.8 GHz to 42 GHz or only in the millimeter wave frequencies greater than 42 GHz. Although the parallel plate waveguide 514 and reflector 516 geometry may be parabolic, the exact curvature may be optimized using simulations of the antenna to optimize the antenna pattern characteristics such as, but not limited to, the gain, sidelobe levels, width and reflected frequencies, etc.

In some examples, the circular array elements 512 are composed of a plurality of antenna elements or may be composed of non-circular elements. The circular array elements 512 may be various types of antennas such as, but not limited to, dipole, monopole, helical, yagi, spiral, parabolic, bow-tie, log-periodic, etc. Additionally, the circular array elements 512 may be configured to transmit on a specific frequency or multiple frequencies. The spacing, orientation, or location of the circular array elements 512 within the parallel plate waveguide 514 and reflector 516 may serve to increase the gain of the system or alter the frequency response of the antenna array 510.

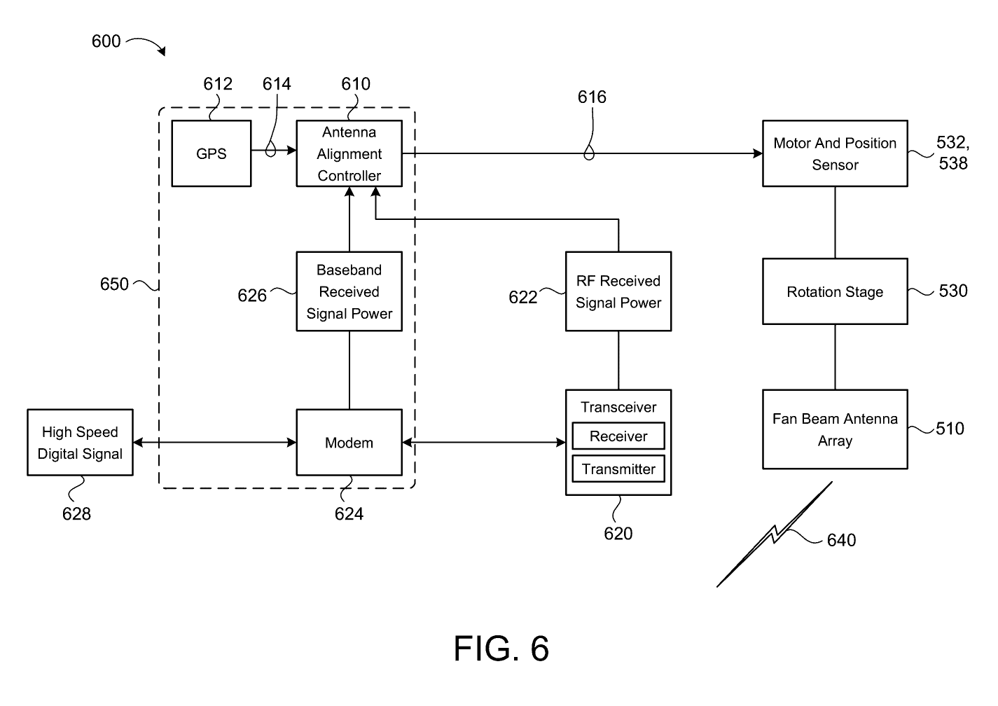

FIG. 6A provides a side view of the fan beam antenna 500 with a rotation assembly 530 attached to the antenna array 510. The rotation assembly 530 includes a motor 532 used to rotate the antenna array 510 by a belt 534 around a rotary joint 540. The motor 532 may be various types so long that it is sufficient to move the antenna array 510, such as, but not limited to, AC, DC, stepper, servo, bushed, brushless, etc. The belt 534 connects the motor 532 to the antenna array 510 and allows the antenna array 510 to be moved around the rotary assembly 530. The belt 534 may be various mechanisms so long that it is sufficient to move the antenna array 510, such as, but not limited to, gears, chains, timing belts, friction drives, etc. The rotary assembly 530 includes a rotary joint 540. The rotary joint 540 may include a shaft 542 to support the antenna array 510. The shaft 542 may support the load of the antenna array 510 while allowing the antenna array 510 to be rotated by the motor 532 and belt 534. The shaft 542 may be supported by a bearing 544 to allow smoother rotation. The shaft 542 may be various types so long that it is sufficient to support the antenna array 510 and allow movement, such as, but not limited to, ball bearings, thrust bearing, tapered bearings, bushings, slide bearings, etc. The rotary stage 540 may include a rotary coupler 546. In some examples, the rotary coupler 546 acts as the shaft 542 and bearing 544 supporting the load of the antenna array 510 and allowing the motor 532 to rotate the antenna array 510. The rotary coupler 546 allows the transmission of signals through a rotating joint while not interfering with the rotation. The rotary coupler 546 may be for infinite rotation or may have a limited rotation. The rotary coupler 546 may be various types, such as, but not limited to, slip rings, rotary radio frequency couplers, or rotary transmission tubes, etc.

FIG. 5C provides a top view of the fan beam antenna 500. The antenna array 510 includes the parallel plate wave guide 514. The parallel plate wave guide 514 includes a broad surface forming a plane. The rotary assembly 530 may rotate the antenna array 510 normal to the broad surface of the parallel plate wave guide 514.

FIG. 5D provides a section side view of the fan beam antenna 500 with a rotation assembly 530 attached to the antenna array 510. In at least one example, the rotation assembly 530 is supported by a support plate 536. The support plate 536 may provide a mounting system to attach the fan beam antenna 500 to the device carrying it, such as a HAP 200. The support plate 536 may include mounting provisions for the motor 532, rotary joint 540 and other items. In at least one example, the antenna array 510 uses a wave guide 550 to transmit the signal to the antenna array 510 from the rotary joint 540. A wave guide 550 is a structure that is used to guide waves, such as an electromagnetic wave. It may be advantageous to use a wave guide 550 for higher frequency transmission to prevent losses associated with traditional cable methods. A position sensor 538 is attached to the rotation assembly 530. The position sensor 538 senses the angle of rotation between the support plate 536 and the antenna array 510. This angle can be reported as an arbitrary or absolute value in reference to a known starting point. The position sensor may be various types, such as, but not limited to, optical, mechanical, electronic, quadrature, encoder, etc.

FIG. 5E provides a bottom view of the fan beam antenna 500. The fan beam antenna 500 includes the antenna array 510 and the rotation assembly 530. The parallel plate wave guide 514 provides a broad surface for attachment of the rotation assembly 530. The signal input 548 may be used to transmit the desired transmission signal to the fan beam antenna 500. In some examples, an enclosure 560 covers the various electronics and systems required for the fan beam antenna 500.

FIG. 6 provides a schematic view of the antenna system controller 600. The antenna system controller 600 includes an antenna alignment controller 610 that receives a location 614 from a GPS 612. In at least one example, the antenna alignment controller 610 compares the location 614 from the GPS 612 to a known location of the ground station 110 to determine how much the antenna array 510 needs to rotate in order to be in alignment with the ground station 110. The antenna alignment controller 610 transmits a desired rotation angle 616 to the motor 532 and position sensor 538. The motor 532 turns the rotation assembly 530 rotating the antenna array 510 until the position sensor 538 is at the desired rotation angle 616.

A modem 624 receives a high speed data signal 628 containing data and information to be transmitted by the antenna array 510 and converts the high speed data signal 628 to a form suitable for the transceiver 620. The transceiver 620 converts the signal from the modem 624 to a suitable form to be transmitted by electromagnetic energy. The transceiver transmits the electromagnetic energy into the antenna array 510, which emits an emission beam 640. The emission beam 640 contains the high speed data signal 628 used for communicating with the ground station 110.

In some examples, the transceiver 620 outputs a radio frequency (RF) received power signal 622 to the antenna alignment controller 610. The RF received power signal 622 is an indication of signal strength of the emission beam 640 being received by the antenna array 510. The modem 624 may also transmit a baseband received signal power 626 to the antenna alignment controller 610. The baseband received signal power 626 may be an indicator of the quality and strength of the baseband carrier wave. The antenna alignment controller 610 can use the RF received power signal 622 and the baseband received signal power 626 to adjust the desired rotation angle 616 of the antenna array 510 for optimum reception. In some environments, due to interference, multi-pathing, or general radio noise, the optimal reception or transmission of the electromagnetic signal may not be a direct line between the antenna array 510 and ground station 110. The antenna alignment controller 610 can use the information from the RF received power signal 622 and baseband received signal power 626 to adjust the angle to mitigate these problems. Additionally, the antenna alignment controller 610 can use the information in the RF received power signal 622 and baseband received signal power 626 to determine if a HAP 200 is traveling out of range or through a null signal spot and may respond accordingly by altering its location, changing the signal power, or transmitting to a different ground station 110. The antenna alignment controller 610 may include data processing hardware 650. The data processing hardware 650 is the necessary hardware to process data including transmissions, positional computations and other necessary information. In one example, the data processing hardware 650 includes the modem 624, GPS 612, and the antenna alignment controller 610. The modem 624 processes general data, such as the high speed data 628. The GPS 612 receives data signals from positional satellites and processes them to determine the current systems location 614. In additional examples, the data processing hardware 650 is a computer processing unit (CPU), microcontroller, peripheral interface controller (PIC), or other controller. The antenna alignment controller 610 processes various information required for the operation of the fan beam antenna 500 including using the location 614 processed by the GPS 612, RF received power signal 622, and baseband received signal power 626 to determine the rotation angle 616.

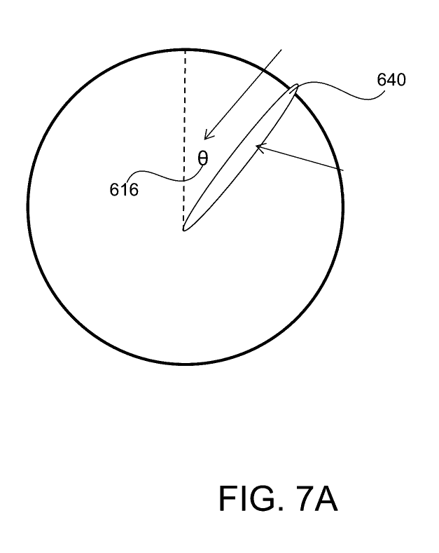

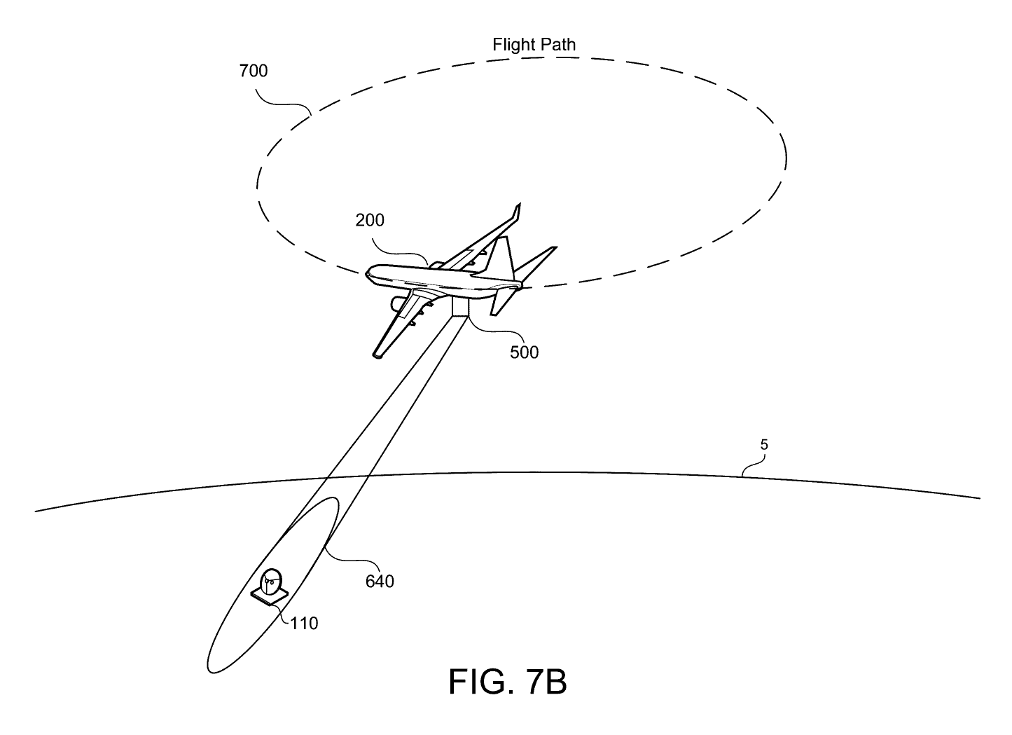

FIG. 7A provides a top view of the emission beam 640 and rotation angle 616 in relation to the ground. Due to the alignment of the array elements 512, parallel plate wave guide 514, reflector 516, and radiating slot 518, the emission beam 640 projects a tall beam when viewed from above, as in FIG. 7A. The array elements 512 radiate electromagnetic energy that impacts the parallel plate wave guide 514 and reflector 516. The parallel plate wave guide 514 and reflector 516 direct the electromagnetic energy through the radiating slot 518 and form the emission beam 640. The rotation assembly 530 steers the antenna array 510 containing the array elements 512, parallel plate wave guide 514, reflector 516, and radiating slot 518 to direct the emission beam 640 location on the ground. The antenna alignment controller 610 maintains the position of the emission beam 640 in contact with the ground station 110. By focusing the emission beam 640 using the array elements 512, parallel plate wave guide 514, reflector 516, and radiating slot 518, the range at which the electromagnetic energy can travel is increased while decreasing the cost and complexity of having a two axis tracking system. The rotation angle 616 is illustrated as the antenna array 510 position has been moved by the rotation assembly 530 from a previous location to a new location creating the rotation angle 616.

FIG. 7B is a schematic view of an exemplary emission beam 640 from the fan beam antenna 500 attached to an HAP 200 in communication with a ground station 110. The HAP 200 flies along a flight path 700 orbiting a position on the earth 5. The flight path 700 may be any flight path 700, including a changing flight path 700, closed loop flight path 700, and is not limited to fixed shapes. As the HAP 200 flied along the flight path 700 the fan beam antenna 500 rotates using the rotation assembly 530 to rotate the antenna array 510 adjusting the rotation angle 616 to maintain the emission beam 640 in contact with the ground station 110. The antenna alignment controller 610 maintains the position of the emission beam 640 in contact with the ground station 110 as the HAP 200 flies along the flight path 700.

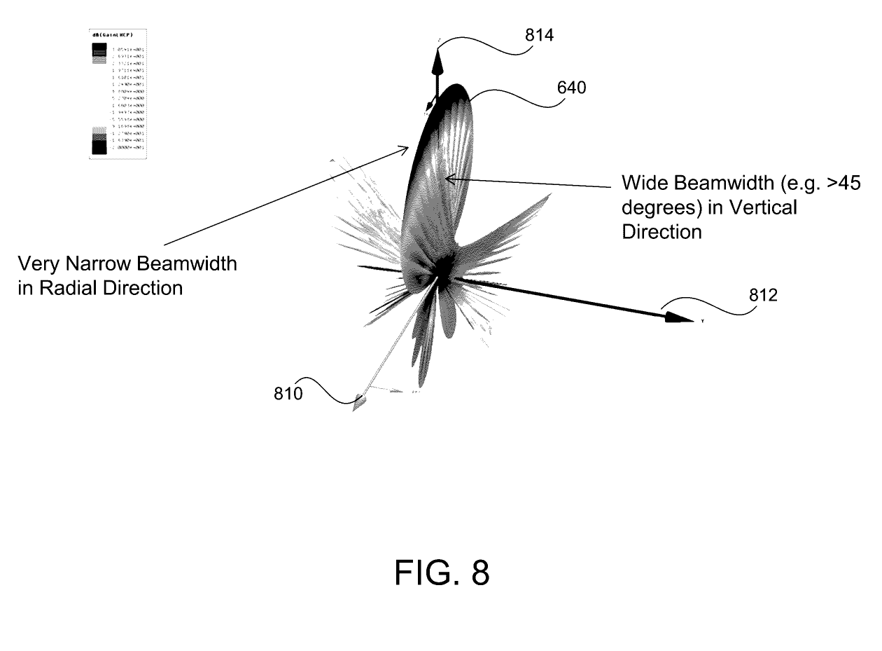

FIG. 8 provides an exemplary view of the emission beam 640. The emission beam 640 is depicted with an imaginary set of coordinate axis, x axis 810, y axis 812 and z axis 814, each of which are at 90 degrees from each other. The emission beam 640 exhibits a wide beam width greater than 45 degrees in the in the x axis 810 and z axis 814. The emission beam 640 exhibits a narrow beam width in the y axis 812.

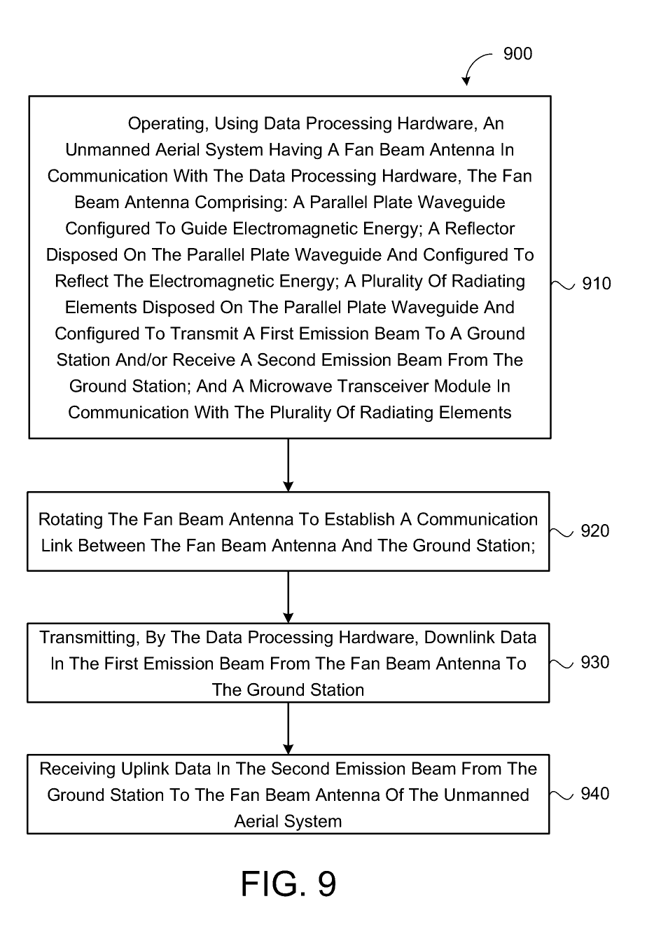

FIG. 9 shows a method 900 for operating a fan beam antenna 500 attached to a HAP 200. At block 910, the method 900 includes operating, using data processing hardware 650, an unmanned aerial system or HAP 200 having a fan beam antenna 500 in communication with the data processing hardware 650, such as a modem 624. The fan beam antenna 500 includes a parallel plate waveguide 514 configured to guide electromagnetic energy. A reflector 516 is connected to the parallel plate waveguide 514 and configured to reflect the electromagnetic energy. A plurality of radiating elements 512 is disposed on the parallel plate waveguide 514. The plurality of radiating elements 512 generates an electromagnetic signal, such as a radio wave. The parallel plate waveguide 514 and the reflector 516 channel the electromagnetic signal generated by the plurality of radiating elements 512 through a radiating slot to form an emission beam 640. The plurality of radiating elements 512 are configured to transmit a first emission beam 640 to a ground station 110 and/or receive a second emission beam 640 from the ground station 110. The data processing hardware 650 uses the electromagnetic energy in the emission beam 640 to transmit and receive data to and from the ground station 110. A microwave transceiver 620 module is in communication with the plurality of radiating elements 512. The transceiver 620 may be configured to drive the emission beam at a microwave frequency or higher. The transceiver 620 may control when the radiating elements are transmitting data or are receiving data.

At block 920, the method 900 includes rotating the fan beam antenna 500 to establish a communication link between the fan beam antenna 500 and the ground station 110. The rotating assembly 530 rotates the fan beam antenna 500. The rotation assembly 530 includes a motor 532 connected to the support plate 536. The motor may drive a belt 534 to control the rotation angle 616. The desired rotation angle 616 may be determined by the antenna alignment controller 610. The antenna alignment controller 610 may read the current rotation angle 616 of the fan beam antenna from the position sensor 538. The GPS 612 may report the location 614 of the fan beam antenna 500 to the antenna alignment controller 610. Using the location 614 the antenna alignment controller can determine the rotation angle 616 in order for the emission beam 640 to contact the ground station 110. At block 930, the method 900 includes transmitting, by the data processing hardware 650, downlink data 628 in the first emission beam 640 from the antenna array 510 to the ground station 110. Once the emission beam 640 is in contact with the ground station 110 data, such as the high speed data signal 628, it may be converted by the modem 624 and transceiver 620 into a format that is acceptable to communicate data using an electromagnetic beam through the emission beam 640. At block 940, the method 900 includes receiving uplink data 628 in the second emission beam 640 from the ground station 110 to the fan beam antenna 500 of the unmanned aerial system or HAP 200. The fan beam antenna 500 may receive data, such as the high speed data signal 628 from the ground station 110. When the fan beam antenna 500 is receiving data from the ground station 110, the parallel plate waveguide 514 and the reflector 516 channel the second emission beam 640 to the plurality of radiating elements 512. The transceiver 620 receives the signal from the plurality of radiating elements 512 and converts it into a suitable form for the modem 624. The modem 624 then converts the signal from the transceiver 620 into a high speed data signal 628.

In at least one example, rotating the fan beam antenna 500 includes rotating the parallel plate waveguide 514 about a rotation axis defined substantially normal to a broad surface of the parallel plate waveguide. The fan beam antenna 500 may be rotated while maintaining the parallel plate waveguide 514 within a plane of rotation. The method 900 may include the step of receiving, at the data processing hardware 650, a first position or location 614 from a global positioning system 612 of the unmanned aerial system or HAP 200. The data processing hardware 650 may then compare the first position or location 614 with a second position or location 614 of the ground station 110. The data processing hardware 650 may then control the rotating of the fan beam antenna 500 to maintain the communication link or emission beam 640 between the fan beam antenna 500 and the ground station 110. The plurality of radiating elements 512 may transmit and receive data, such as the high speed data signal 628 at a frequency greater than 5.8 GHz. The emission beam 640 may have a half power full beam height along a first axis, such as the x axis 810, of between about 0.1 degrees and about 5 degrees and a beam width along a second axis, such as the y axis 812 perpendicular to the first axis of between about 10 degrees and about 70 degrees. A number of implementations have been described. Nevertheless, it will be understood that various modifications may be made without departing from the spirit and scope of the disclosure. Accordingly, other implementations are within the scope of the following claims.

What is claimed is:

1. A fan beam antenna comprising:
a parallel plate waveguide configured to guide electromagnetic energy of an emission beam;
a reflector disposed on the parallel plate waveguide and configured to reflect the electromagnetic energy of the emission beam;
a plurality of radiating elements disposed on the parallel plate waveguide and configured to transmit and/or receive the electromagnetic energy of the emission beam;
a microwave transceiver module in communication with the plurality of radiating elements; and
a rotation assembly disposed on the parallel plate waveguide and configured to rotate the parallel plate waveguide about a rotation axis defined substantially normal to a broad surface of the parallel plate waveguide.

2. The fan beam antenna of claim 1, wherein the rotation axis is the sole axis of rotation.

3. The fan beam antenna of claim 2, wherein the rotation assembly is configured to rotate the parallel plate waveguide while maintaining the parallel plate waveguide within a plane of rotation.

4. The fan beam antenna of claim 3, wherein the rotation assembly comprises:
a motor coupled to the parallel plate waveguide; and
a position sensor configured to sense an angle of rotation of the parallel plate waveguide about the rotation axis.

5. The fan beam antenna of claim 4, wherein the rotation assembly further comprises an antenna alignment controller in communication with the position sensor and the motor, the antenna alignment controller configured to control the angle of rotation of the parallel plate waveguide about the rotation axis by:
comparing a first position of the fan beam antenna with a second position of the ground station; and
determining an alignment angle of rotation of the parallel plate waveguide about the rotation axis to establish a communication link between the fan beam antenna and the ground station.

6. The fan beam antenna of claim 1, wherein the transceiver module comprises a modem configured to provide data to the plurality of radiating elements.

7. The fan beam antenna of claim 1, wherein the plurality of radiating elements is configured to transmit and receive data at a frequency greater than 5.8 GHz.

8. The fan beam antenna of claim 1, wherein the emission beam has a half power full beam height along a first axis of between about 0.1 degrees and about 5 degrees and a beam width along a second axis perpendicular to the first axis of between about 10 degrees and about 70 degrees.

9. A communication system comprising:
an unmanned aerial system and comprising:
a rotation assembly disposed on the unmanned aerial system and rotatably supporting the fan beam antenna;
a fan beam antenna disposed on the unmanned aerial system and comprising:
a parallel plate waveguide configured to guide electromagnetic energy of an emission beam;
a reflector disposed on the parallel plate waveguide and configured to reflect the electromagnetic energy of the emission beam;
a plurality of radiating elements disposed on the parallel plate waveguide and configured to transmit and/or receive the electromagnetic energy of the emission beam; and
a microwave transceiver module in communication with the plurality of radiating elements; and
a ground station in communication with the fan beam antenna disposed on the unmanned aerial system.

10. The communication system of claim 9, wherein the unmanned aerial system moves along a closed loop path and the rotation assembly rotates about a rotation axis defined substantially normal to a broad surface of the parallel plate waveguide to maintain communication with the ground station.

11. The communication system of claim 10, wherein the rotation assembly is configured to rotate the fan beam antenna while maintaining the parallel plate waveguide within a plane of rotation.

12. The communication system of claim 11, wherein the rotation assembly comprises:
a motor coupled to the parallel plate waveguide; and
a position sensor configured to sense an angle of rotation of the parallel plate waveguide about the rotation axis.

13. The communication system of claim 12, wherein the motor rotates the fan beam antenna in relation to a signal strength of the emission beam.

14. The communication system of claim 12, wherein the unmanned aerial system comprises:
a body;
a global positioning system disposed on the body; and
an antenna alignment controller in communication with the global positioning system, the position sensor, and the motor, the antenna alignment controller configured to control the angle of rotation of the parallel plate waveguide about the rotation axis by controlling the motor.

15. The communication system of claim 14, wherein the antenna alignment controller controls the angle of rotation of the parallel plate waveguide about the rotation axis by:
comparing a first position determined by the global positioning system with a second position of the ground station; and
determining an alignment angle of rotation of the parallel plate waveguide about the rotation axis to establish a communication link between the fan beam antenna and the ground station.

16. The communication system of claim 9, wherein the plurality of radiating elements is configured to transmit and receive data at a frequency greater than 5.8 GHz.

17. The communication system of claim 9, wherein the emission beam has a half power full beam height along a first axis of between about 0.1 degrees and about 5 degrees and a beam width along a second axis perpendicular to the first axis of between about 10 degrees and about 70 degrees.

18. A method comprising:
operating, using data processing hardware, an unmanned aerial system having a fan beam antenna in communication with the data processing hardware, the fan beam antenna comprising:
a parallel plate waveguide configured to guide electromagnetic energy;
a reflector disposed on the parallel plate waveguide and configured to reflect the electromagnetic energy;
a plurality of radiating elements disposed on the parallel plate waveguide and configured to transmit a first emission beam to a ground station and/or receive a second emission beam from the ground station; and
a microwave transceiver module in communication with the plurality of radiating elements; and
rotating the fan beam antenna to establish a communication link between the fan beam antenna and the ground station by rotating the parallel plate waveguide about a rotation axis defined substantially normal to a broad surface of the parallel plate waveguide;
transmitting, by the data processing hardware, downlink data in the first emission beam from the fan beam antenna to the ground station; and
receiving uplink data in the second emission beam from the ground station to the fan beam antenna of the unmanned aerial system.

19. The method of claim 18, wherein the rotation axis is the sole axis of rotation.

20. The method of claim 18, further comprising rotating the fan beam antenna while maintaining the parallel plate waveguide within a plane of rotation.

21. The method of claim 18, further comprising:
receiving, at the data processing hardware, a first position from a global positioning system of the unmanned aerial system;
comparing, at the data processing hardware, the first position with a second position of the ground station; and
controlling, by the data processing hardware, the rotating of the fan beam antenna to maintain the communication link between the fan beam antenna and the ground station.

22. The method of claim 18, wherein the plurality of radiating elements is configured to transmit and receive data at a frequency greater than 5.8 GHz.

23. The method of claim 18, wherein each emission beam has a half power full beam height along a first axis of between about 0.1 degrees and about 5 degrees and a beam width along a second axis perpendicular to the first axis of between about 10 degrees and about 70 degrees.

24. The method of claim 18, further comprising transmitting the downlink data in the first emission beam from the fan beam antenna to the ground station via an electromagnetic wave having a frequency greater than about 30 GHz.
